(19) United States
(12) Patent Application Publication
(10) Pub. No.: US 2011/0050652 A1
(43) Pub. Date: Mar. 3, 2011

(54) Flexible and portable multiple passive writing instruments detection system

(76) Inventor: David H. Chan, Richmond Hill (CA)

(21) Appl. No.: 12/552,281

(22) Filed: Sep. 1, 2009

(51) Int. Cl. G06F 3/033; G02B 5/20; G02B 5/10; G01B 11/00

(52) U.S. Cl. 345/179; 359/601; 359/850; 356/400

(57) ABSTRACT

A system, method and apparatus for converting writing on surface to digital signal for further processing. A specially designed object which is a very cost effective passive method, helps to identify true multiple passive writing instruments writing at the same time, and can works with most passive writing instruments including human finger, pen, stick, chopstick, laser pointer and any pen a-like objects as well as regular pens. Laser pointer light beam can be identified as a writing instrument and can function similarly as a mouse function or other functions. A reflection mirrors system makes the system flexible and adjustable to work with any existing writing area at any size and can be a true portable system. An additional light sub-system enhances the captured image at any ambient light condition. A laser sub-system helps for easier installation and setup.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Digitize hand writing on surface is a huge effort all the time. Many inventions aim on this function for many years already, but all have similar kind of disadvantages. Most of the inventions are based on technologies of “Inferred light with IR transmitter and receiver”, “Ultrasonic transmitter and receiver”, “CMOS light sensor with IR transmitter”, “touch screen”, “camera” and “electromagnetic” etc. A specially designed electronics pen is necessary in most of the cases. A high cost touch screen or magnetic panel may be used. There are limited number of products can detect “Passive writing instrument” like human finger writing. Quite often, more than one method are used in one system. All the existing products are designed for fixed writing panel format like whiteboard. Some touch panels are installed in front of display unit to form an interactive writing panel. All these methods have some or all typical disadvantages as follows: (1) High cost (2) Specially designed writing instrument (3) High cost touch screen for passive writing instrument, like finger access (4) Cannot use any pen a-like writing instruments (5) Difficult or cannot truly identify multiple writing instruments which are writing at the same time(6) Difficult or cannot works with existing projector screen (7) Fixed installation and NOT portable. (8) Sensors are installed at corner of writing area and reduced the effective writing area (9) Cannot identify true multiple “Passive writing instrument” like multiple fingers writing (10) Do not identify multiple writing instruments but only electronic pens (11) Cannot use true different writing instruments at the same time, for example: finger, chopstick, regular whiteboard pen at the same time. U.S. Pat. No. 6,266,051 is a retrofittable system which can be mounted to existing writing area for easier mounting but not true portable. (12) Linear distortion of wide angle lens as well as pin hole. U.S. Pat. No. 6,917,033 use optical marker to identify “Passive touch” but is a costly, cumbersome and not easy to implement. U.S. Pat. No. 6,803,906 use CMOS cameras to detect “Passive touch” but is not a flexible and portable system as well as use “substantially rectangular frame” around the writing area to help for detection. All these disadvantages limited the function of “multiple passive writing instrument” detection, “flexibilities”, “portability” and “affordability”. These limitations drawn forward my new invention.

### BRIEF SUMMARY OF THE INVENTION

The new invention is using mature and existing image capture technologies to detect writing objects. Image sensors are installed in a box which will be placed at any edge or corner of the writing area which is not necessary to be traditional rectangular and the invented system is flexible to be adjusted to match with any size of writing area to form a true flexible and portable system which prior arts do not provide. Mirrors are installed at corner of the writing area to project images back to the image sensors to fully utilize the writing area which prior arts do not provide as well as other advantages. A special designed, very cost effective “Passive” method is used to identify passive writing instruments in any form which prior arts cannot provide at all. The newly invented system is very cost effective which prior arts are not. The new invention solved all or most of the disadvantages described above in section [0005] especially “affordability”.

### BRIEF DESCRIPTION OF THE SEVERAL VIEWS OF THE DRAWING

FIG. 1: depicts an invented system which is including image sensors, minors, light shade, IR filters, batteries, electronics board including micro-controller, rod, rod holder, hooks and mirror holder.

FIG. 2: depicts more detail sample view of the invented system which is including components in FIG. 1. Specially designed light shade position and shape which has wide angle of looking toward to monitored writing area. The position of IR filters and the holder of rods.

FIG. 3: depicts details of the special designed minor which is special designed curved minor to cover any angle of view by changing the curved shape of the mirror. The mirror holder is specially designed to have recessed mirror to reduce the effect of ambient light.

FIG. 4: depicts details of the relationship between the invented system and writing area to show how the image sensors look at the monitored area and the relationship between the system and the writing object and the trigonometry relationship for writing instrument location calculation.

FIG. 5 and FIG. 6: depicts details of the disadvantages of pin hole camera or image sensor and regular camera or image sensor which are installed at the corner or side of writing area. Both camera have minimum distance for taking image as well as other disadvantages shown.

FIG. 7: depicts details of the disadvantages of pin hole camera and regular camera to be installed at the corner of writing area. These disadvantages are: (1) Difficult to have 90 degrees or larger of field of view to cover the whole area. (2) Minimum object distance reduced and limited the effective monitored area. (3) The writing instrument blocked the field of view of camera or image sensor when the object is close to the camera because the pinhole and the lens are small. (4) The object reduced the viewed area very much even not too close to the camera or image sensor because of the size of pinhole and lens are much smaller in compare with the writing instrument as well as a finger. (5) Linear distortion of wide angle lens as well as pin hole.

FIG. 8: depicts details of the difference between the invented system and the camera which is to be installed at the corner of the writing area. The writing object is much smaller than the minor, thus the blocked area (shadow area) created by the writing object is much smaller in compare with the pin hole and regular camera which are installed at the corner. Detection of multiple objects will be much more easier and accurate. Minimum distance is moved away from the corner, thus eliminate the minimum distance limit and fully utilize the monitored area. When the object comes in front of the minor, the object only blocks part of the mirror and thus the camera still can see the area around the writing instrument also.

FIG. 9: depicts the usage of the invented system with curved surface. The figure showed two invented systems are used, however it can be more than one invented system and depends on the shape of the curved area.

FIG. 10: depicts the details of the label/object which are used to identify writing instruments including finger. Strip or strips are on the label/object to help to be identified, hence different writing instruments can be identified as well as different fingers. Any materials can be used as long as the characteristic difference between the strip and label body is good enough for identification by camera or image sensor.

FIG. 11: depicts the details of the invented system to works with projection system, computer system, PDA and other electronics systems via wired and/or wireless communication links.

FIG. 12: depicts the details of the “Laser calibration sub-system” which is for system setup purpose. The laser sub-system help to setup and adjust the mirrors to project a correct image to the image sensors.

FIG. 13: depicts the details of the “LED light sub-system” which includes a LEDs array and a light diffuser which will diffuse the light of LEDs to form a patterned diffused light source to light up the monitored area and writing objects.

FIG. 14: depicts the concept of the “Light reflector” which is using to enhance the laser light beam spot pick up if necessary. The special designed surface helps to reflect more light to sideway, means more reflection light to camera or image sensors.

### DETAIL DESCRIPTION OF THE INVENTION

According to an aspect of an embodiment of the invention, there is provided a system including: image sensors which is installed in a case with no, fixed or special relationship in between sensors. At least one system can be mounted on any writing area or apparatus at one side or more than one side of the monitored area. It can be any one side or corner but not fixed to one particular side or corner. The image sensors monitor the area through two mirrors. The specially designed light shades and the filters reduce the effect of ambient light to improve image detection result. The system is powered by batteries with charging capability by external power as well as using external power for extended time usage, thus can be a portable or permanent system and can be installed on any surface, for example: white board, wall, rough wall, note pad and projector screen etc. There are two rods which are used to hold the mirrors at the ends by minor holders, the mirror holder is adjustable to match with different size of writing area. These rods are inserted into rod holders on the case to form a complete system. These rods are changeable as well as telescopic rods as alternative, thus the system can be a portable system works with different size monitored area but not only fixed size area and is fully flexible. There are mounting hooks to hold the rods, then the system will be hung on the hooks on top of the monitored area or by any other mounting method to be held at any position. The image sensors monitor the writing area through the reflection minors and pass the information to processing unit to calculate the location of the writing instrument which can be any passive writing instruments like finger, pen or a-like, even laser pointer light beam, by simple trigonometry method. The calculated data then can be processed by either the processing unit, other processing unit, personal computer or any internal or external electronics devices to perform any actions. For example: These data can be sent to projector to update the projected image on screen to synchronize the projected image and the writing with or without personal computer system or other electronics systems. Identify passive writing instruments like finger for writing and multiple passive writing instruments writing on the writing area at the same time is always be a huge challenge so far. For example: If the first finger stay on board and the second finger pop in to do zoom in and out function or rotating function are simple and is using by many manufacturers right now, for example: iPhone. But, if the first finger writes some thing at left side of board then left up, then second finger pop in and writes some thing at right side of board, then all the known prior arts cannot identify the second writing is written by first finger or second finger unless by electronics pen method. By using the invented label/object passive method, the said problem vanished and indentify multiple passive writing instruments at low cost are possible. The label/object is specially designed label/object which helps to identify passive writing instruments like finger, pen etc. as well as multiple passive writing instruments by this passive method, thus fingers of different persons can be truly identified as well as different writing instruments. The label/object for identification can be any form, for example: in label form, ring form, sleeve form etc. So, different writing instruments can be identified and write on the area and can be truly identified by the system at much lower cost with this specially designed passive identification method, and is practical. U.S. Pat. No. 6,917,033 with title “Passive touch-sensitive optical marker” is a way to identify passive writing instrument by using optical reflector. However, this method is expensive, difficult to manufacture, cannot identify multiple passive writing instruments and not easy to use in compare with this invention. The image sensors capture images via the reflection mirrors and identify the related angle and then calculate the intersection of two projection lines to locate the writing instrument location by the invented passive identification label/object and further calculate the movement. The image sensors identify the writing object by reading the attached label/object which have different quantity of special shape including strip etc. with different material. The shape or strip give different image in the form of different thermo and/or brightness characteristic to the image sensors because of different temperature coefficient than the label/object body as well as different light reflection factor than the label/object body and writing instrument. These temperature and light reflection differences can be detected easily by image sensing with image sensors. The strips or shapes on the identification label/object can be any type of materials as long as the combination of shape/strip and label/object body have different characteristics to be detected by image sensors. On the other hand, any materials combinations will work as long as can be identified by the image sensors. A subsystem of LEDs array and diffusion filter assembly can be installed with the system to provide additional heat and/or light if necessary. The light source can be any type of light but not limited to LEDs and the filter is used to diffuse the light to form a designed patterned light source as needed. A subsystem of laser pointer and receiver, calibration mirrors with optional image display also mounted with the main system to help to calibrate the system when installation. The invented system corrected disadvantages of prior arts as follows: (1) “High cost”—No more high cost, the invented system is using mature existing image sensing technologies which is very cost effective in these days as well as passive multiple writing instruments detection instead of high cost electronics pen method. (2) “Specially designed pens only”—No more high cost special designed electronics pens. Using image recognition method to identify writing instrument. (3) “Limited usage of finger”—The invented system do not have any limitation of using finger. (4) “Regular pen or electronics pen only”—The invented system can use any pen a-like objects as writing instrument, and do not limit to pen size too. (5) “Difficult to identify multiple writing instruments”—Truly identify multiple writing instruments including fingers by low cost passive identification method. (6) “Difficult to work with projector screen”—Any pen alike writing instruments can work with projector screen. No electronic pen is necessary because of using image recognition method. (7) “Not portable”—The invented system is designed to be adjustable and flexible to match with any size writing area as well as to be removable to act as portable system. (8) “Not fully use of writing area”—The invented system is using mirror to capture image and fully utilize the writing area. (9) “Cannot identify multiple fingers”—The invented system is using specially designed low cost passive identification method to truly identify multiple writing instruments including fingers. (10) “Cannot use multiple different writing instruments at the same time”—The identification method of the invented system is neutral to any writing instruments, thus different writing instruments can be used and identified at same time. For example, a finger, chopstick and a fork can be writing instrument and can be identified and using for writing at the same time. Additional advantage is the specially designed label/object can be “Disposable” to meet hygiene concern. Patent No. 7236162/6803906 with title “Passive touch system and method of detecting user input” are using camera to do image identification and is similar to this invention. However, these 2 patents have similar problems as listed above in section [0005], the systems are not flexible and are not portable as well as cannot identify multiple passive writing instruments. So, this invention is better, lower cost and more practical than the said 4 patents, U.S. Pat. No. 7,236,162, 6,803,906, 6,917,033 and 6,266,051, but not limited to.

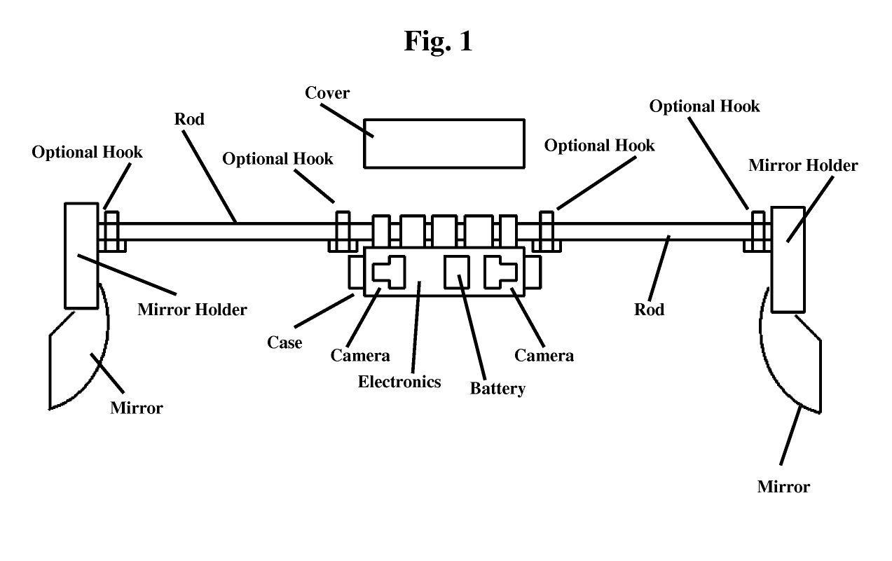

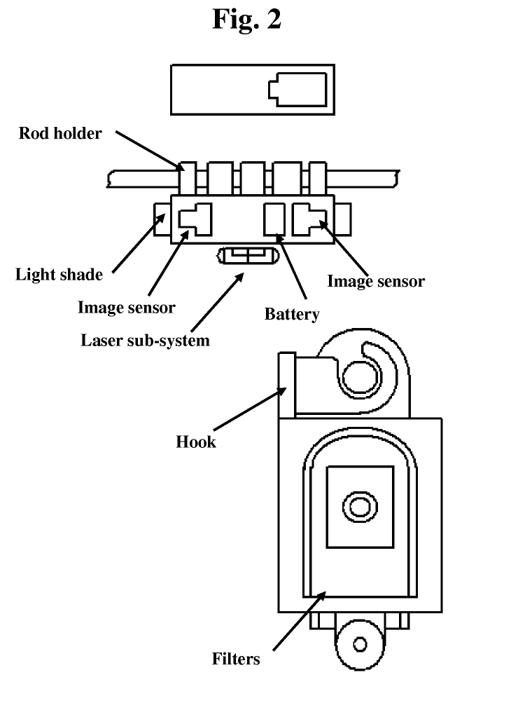

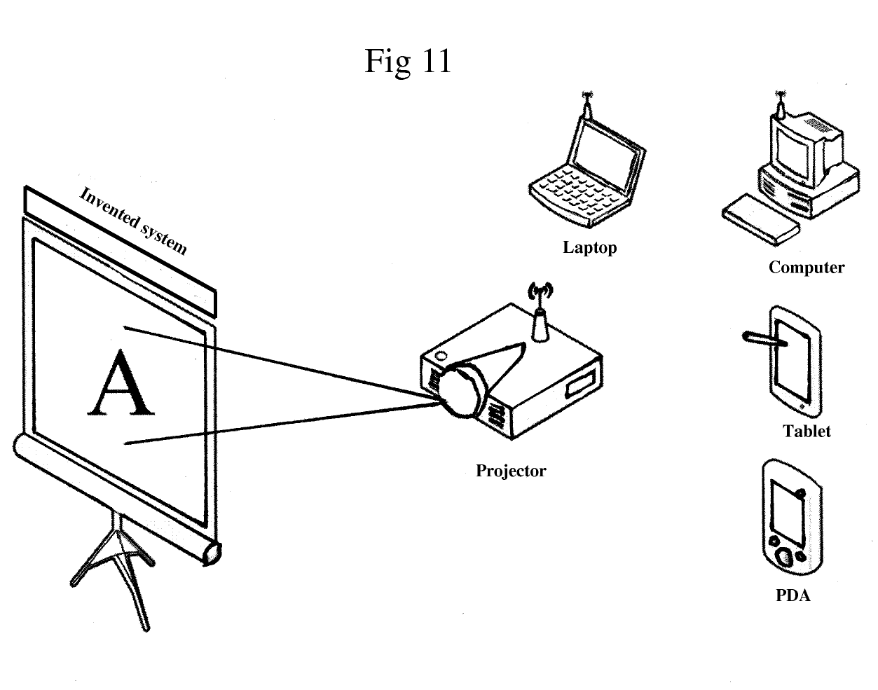

1. An invented system which includes (1) image sensors, (2) mirrors, (3) writing instruments, (4) Specially designed light shades, (5) Filters including IR filters, (6) batteries, (7) electronics (8) specially designed rods holders, (9) mirror holders, (10) rods (11) hooks, (12) Light sub-system, (13) Laser pointer sub-system, (14) Specially designed passive label/object as additional to the writing instruments, (15) Serial communication with other electronics systems including USB, LAN, regular serial communication like RS232. The invented system works as either a fixed digitizer system with a writing area or a portable system to work with any writing area and/or instruments. The invented system is flexible and adjustable to match with any existing writing area of any size and shape or part of the existing writing area, for example: existing whiteboard in class room or conference room in business. See FIG. 1 to FIG. 2. The invented system works effectively with any projector screen by using any pen a-like writing instruments including laser pointer and laser pointer light beam. For example: finger, chopstick, stick, pen etc. The invented system works with a computer system and projector or special designed smart projector which has communication capability. This new invented system solves the traditional “Impossible writing on traditional projection screen” issue as well as identification of multiple passive writing instruments. See FIG. 11. The image sensors are refer to any image sensors with adjustable optical lens assembly, including color camera, black and white camera, IR camera, CMOS camera, CCD camera, thermo imaging sensor, but not limited to above listed. The system uses dynamic exposure and shutter control of image sensors to work with different light conditions for the best image pickup result. Image information is passed to the electronics for processing and transfer to other system internally and/or externally.

2. The specially designed light shades and filters including IR filters are installed in front of the image sensors. The specially designed light shade are used to block direct ambient light to the image sensors. The shades have special shape to allow the image sensors look toward the writing surface easily. Different shape and/or additional adaptors can be added to the original shades to change the blocking characteristic to meet different purposes if necessary. See FIG. 2. The specially designed filters are IR filters as well as other filters, are used to enhance image pick up and are more sensitive to particular wave length of light for the purpose of writing instruments identification. The light shade, mirrors, rods, filters etc. and image sensors can be positioned in the case at any location and faced to different directions to match with the writing area monitor need but not just the locations and directions as shown in diagrams.

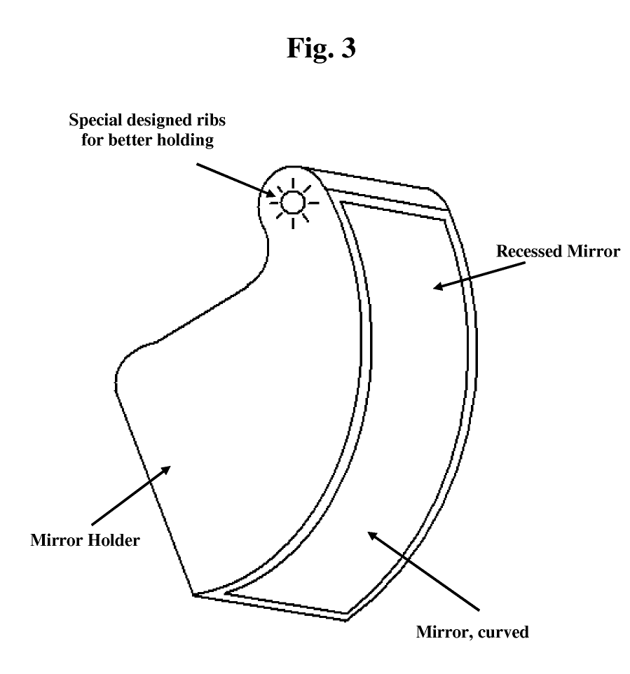

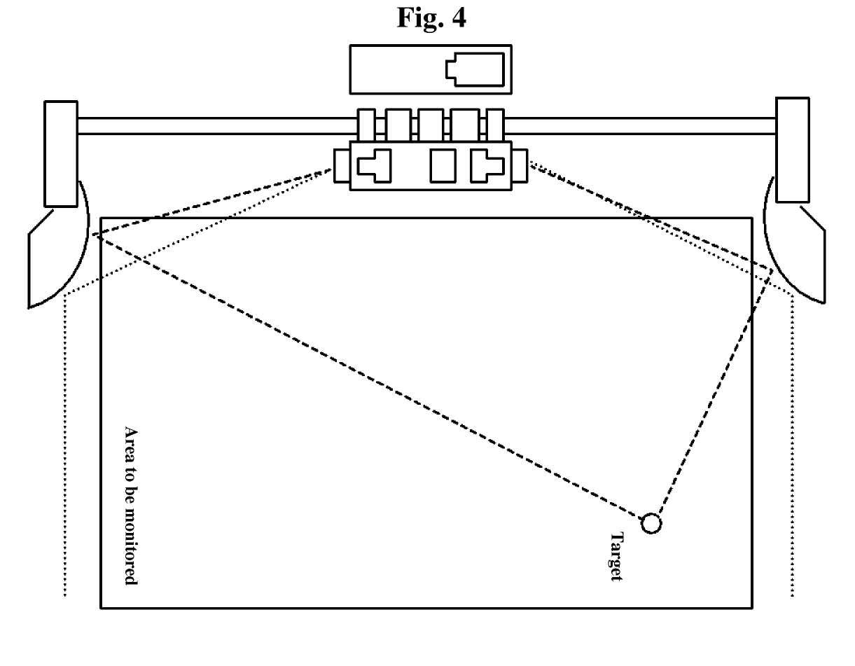

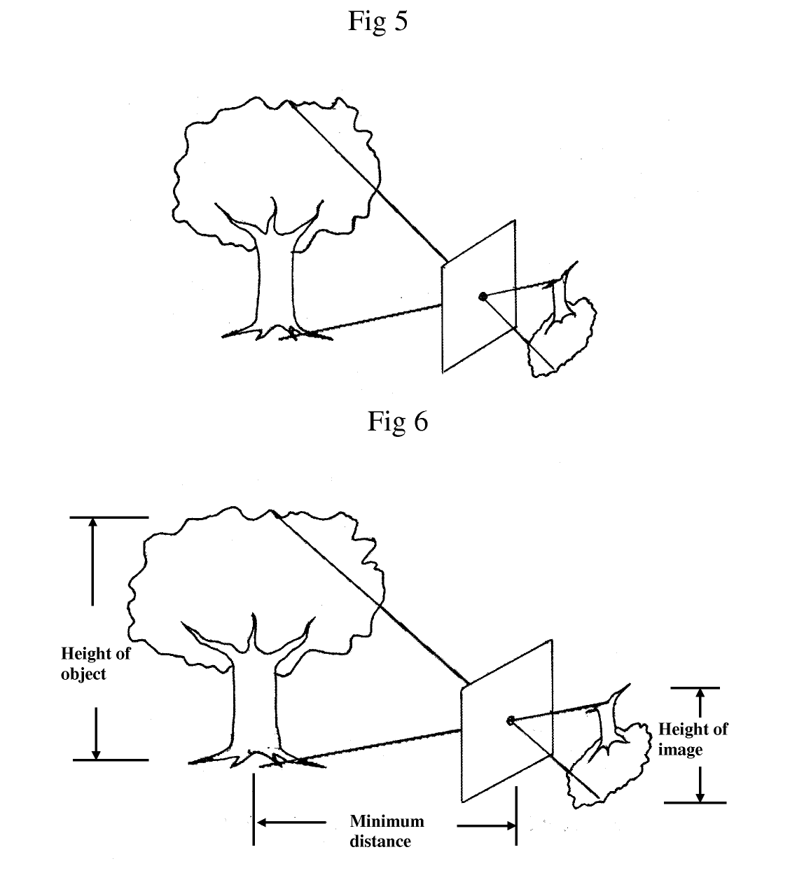

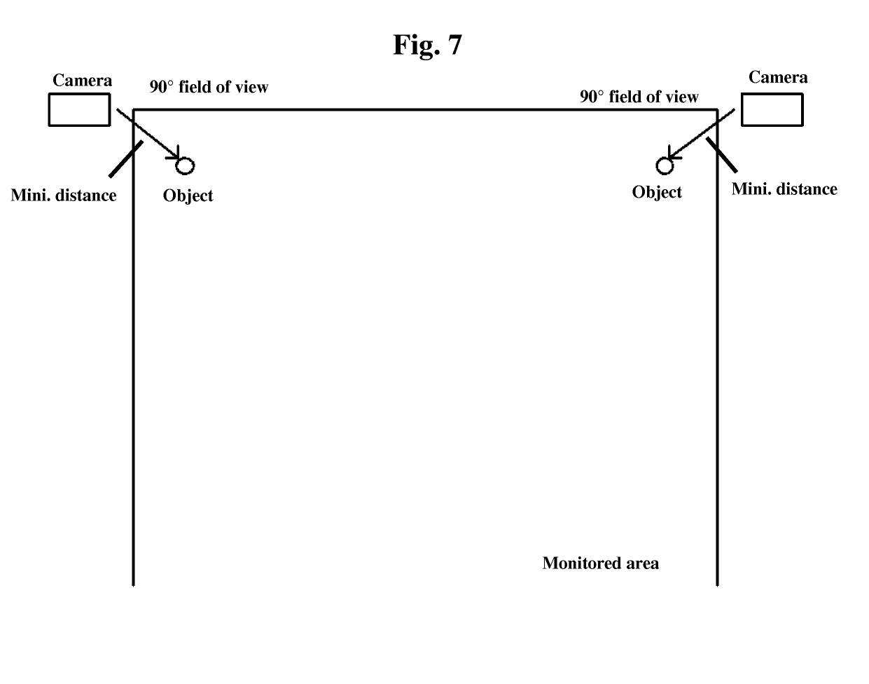

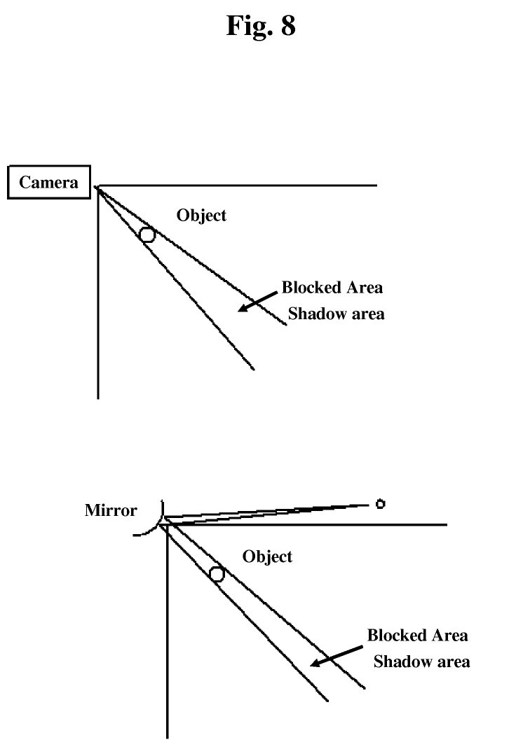

3. The minors of claim 1 reflect images to image sensors for processing. The mirrors are specially designed to have a curved surface in any or any combinations of X, Y and Z axis. The minor can be curved to any axis at any angle including zero degree. The minors are installed to the minor holders which are installed to the rods for a flexible and/or portable system. Also, the mirrors can be installed to a fixed writing area directly for a fixed system without mirror holding rod as well. Using the mirrors can eliminate disadvantages such as linearity issue of installing the image sensor at corner of writing area. See FIG. 3 to FIG. 8. The minors also can be combined with the case to form a complete system and the minors can be moved inside the case to match with the monitored writing area also but not limited to be as shown in drawings. On the other hand, it means moving the minors and rods assembly inside the case. The minor holder is used to hold minor for reflecting images to the image sensors. The mirror holders are to be held at the end of the rod and are adjustable to support flexible and/or portable system. The mirror holders can be combined with the case too.

4. The writing instruments of claim 1 can be any kind of writing instruments including human appendage, animal appendage, pen, stick, chopstick, laser pointer and laser pointer light beam, any pen a-like objects or any objects that can be held by human hand, animal or robot to perform a writing action. Writing instruments work with special designed label/object for identification purposes. The writing instruments are pen a-like but does not means the size and shape are limited to be the same as a regular pen.

5. The batteries of claim 1 can be any type of batteries including disposable and rechargeable. External power can be connected for continuous operation as well as charging. External power includes external or internal AC/DC adaptor/circuit, DC power source, DC power from USB connection, power on LAN and wall AC/DC adaptor as well as other suitable sources.

6. The electronics of claim 1 includes one or more processors, is the brain of the system to control other electronics, sub-systems and components including image sensors to pick up images, analyze images and digitize the image as well as calculation of location and movement of writing instruments. The processor also has communication capability to communicate with external processing units, personal computers or other processing equipments for further action and activities. Communication can be carried out by any regular wired and/or wireless analog and/or digital communication method including any serial communication as RS232, USB, LAN etc. The processor will detect and collect the operating behavior and retain in database internally and/or externally, in memory, drives, CD, DVD, computer system or any other electronics storage components and/or systems. The writing data include raw and/or processed data retain internally and/or externally in any type of storage devices and systems including any flash memory storage devices like SD card etc. as well as to be delivered to external devices by any communication method.

7. The rod holder of claim 1 is divided to pieces to form holders to provide easy rods assembly and disassembly. The rods can be taken off from the case for easy storage and transportation to make the system portable or used as a fixed system. See FIG. 2. The rods of claim 1 are used to hold minor holders which are used to hold mirrors. Rods are used with hooks for installation. Rods can be different length and shape to suit different monitored writing area size. Rods can be telescopic for more flexibility in length for either fixed or portable system to match with different writing areas and sizes. The hooks are used with the rods for holding the system to the writing area. These hooks can be any size and shape to match needs. See FIG. 1. The said rods and mirrors of claim 1 can be combined with the case as a complete cased unit either in different length by manufacturing or with telescopic function. Image sensors in the case can be moved to different positions and/or different separation in between two image sensors to further enhance the effect of covering different size of writing area.

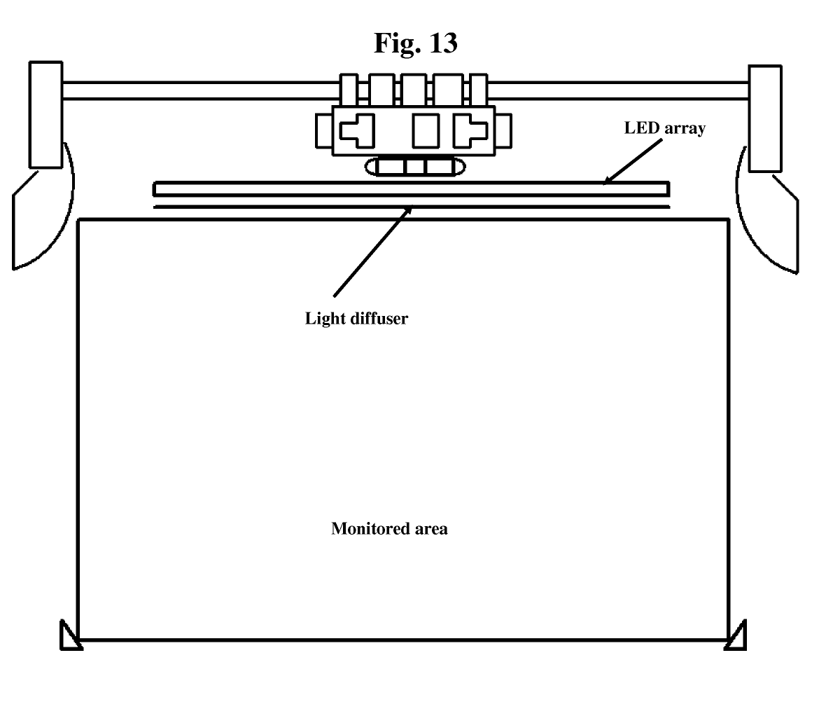

8. The light sub-system of claim 1 is formed by a LED array and one or more diffuser lens in front of the LED array to diffuse the light to form a patterned and diffused light to any axis as necessary, to warm up and/or light up the monitored area, identification label/object and writing instruments when necessary. The light sub-system can be any type of light including visible light, IR and/or combination of lights in different wave length. The light diffuser can be glass, plastic or any materials and in any shape and surface in any form of diffusion to any axis which is suitable for the purpose. The light sub-system can be in any form but not just linear form and is to be installed at any edge and level of the monitored area and/or any corners at any angle. The light sub-system also can be controlled by the electronic system to have steady and/or pulsed modes as well as synchronization with the system as required. The light sub-system is controlled by the system electronics to have static and synchronized pulsed dynamic modes for enhanced image capture. The light sub-system is synchronized with the image sensors in synchronized pulsed dynamic mode for enhanced image capture. See FIG. 13

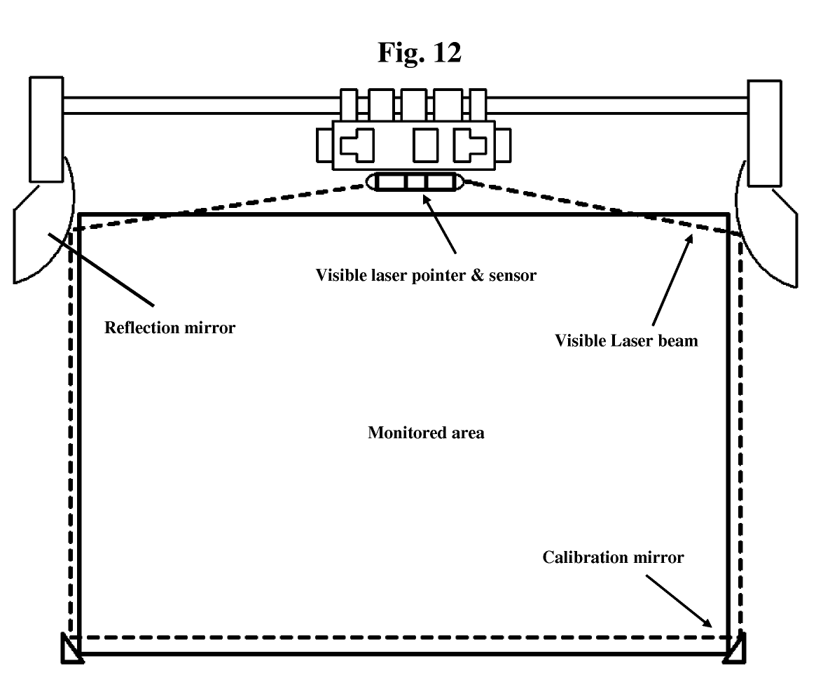

9. The laser sub-system of claim 1 includes a low power visible laser pointer or laser beam like light beam source, light sensor and calibration minors. The visible light source emits a visible light to the reflection mirrors, calibration minors and travel back to the light sensor. This will help to calibrate the position of the two refection mirrors of the system to cover the whole writing area which can be any shape and size. See FIG. 12. A display unit which can be LCD, OLED or any other type can be connected to the system to display the captured images to assist with installation, adjustment and calibration. The display unit also can be any external electronic equipments including monitors and personal computer for the purpose. The images which are captured by the image sensors of the invented system are delivered to the display unit by any communication method including wired and wireless communication methods. See FIG. 12

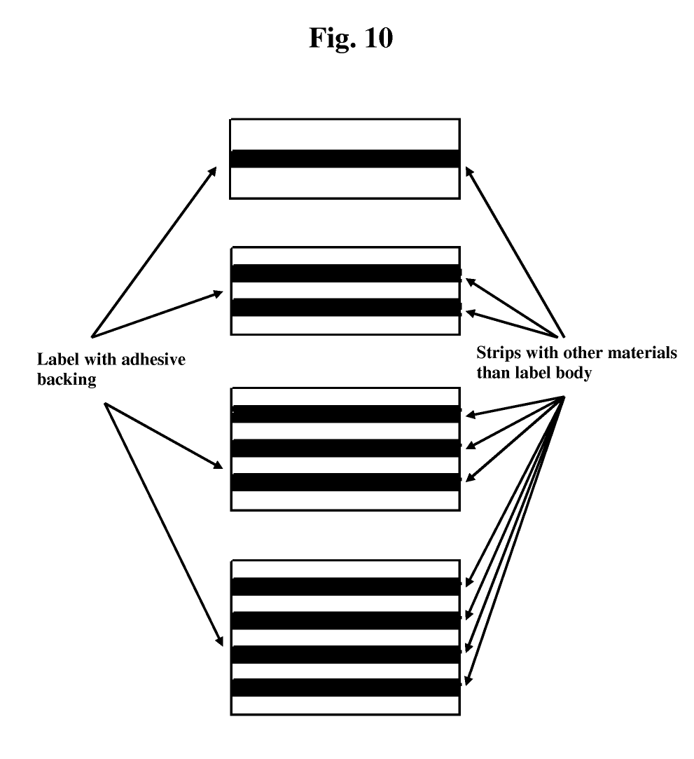

10. Specially designed label/object of claim 1 is for writing instrument identification. The label/object is to be installed to the writing instrument at any appropriate location which normally is the tip area. The label/object has a secondary material which has a different temperature coefficient and different light reflection factor than the label/object body as well as writing instrument body. The secondary material is to be seen by the image sensors as additional marking on the label/object or writing instrument because of the different temperature coefficient and different light reflection factor. For example: two strips of secondary material on the label/object can be seen by the image sensors as 2 strips, one strip of secondary material on the label and can be seen as 1 strip, thus respectively, writing instrument number 2 and number 1. The label/object with no secondary material on it means pen number 0 (zero) and same for a writing instrument without any label/object on it. So, three writing instruments can be identified by this passive method and writing within the writing area at the same time with no mix up at all. This method can be applied to many writing instruments but not just 3. The said secondary material can be more than one secondary material as necessary. This is an effective passive method for identification and do not involve any active electronics at all. The secondary materials can also be any kind of material as long as possessing said effects, but not necessary to be different temperature and light reflection characteristics only, and the material can be added to the label/object as well as writing instrument by any method including bonding, printing, injection, double injection molding. The secondary material can also be added to writing instrument via adhesive label, by any objects like a ring, sleeve etc. The label/object can be any material including paper, plastic, fabric and metal foil. The secondary material can be in any form as a dot, strip, bar, line etc. with any shapes like circular, square, diamond, character, company logo etc. and can be 2D and/or 3D shapes. Writing instrument with no identification label/object will be treated as writing instrument number zero. This method is very easy to implement at very low cost. The secondary material can have other characteristics and not only temperature coefficient and light reflection factor as long as it can be identified by image sensors. See FIG. 10

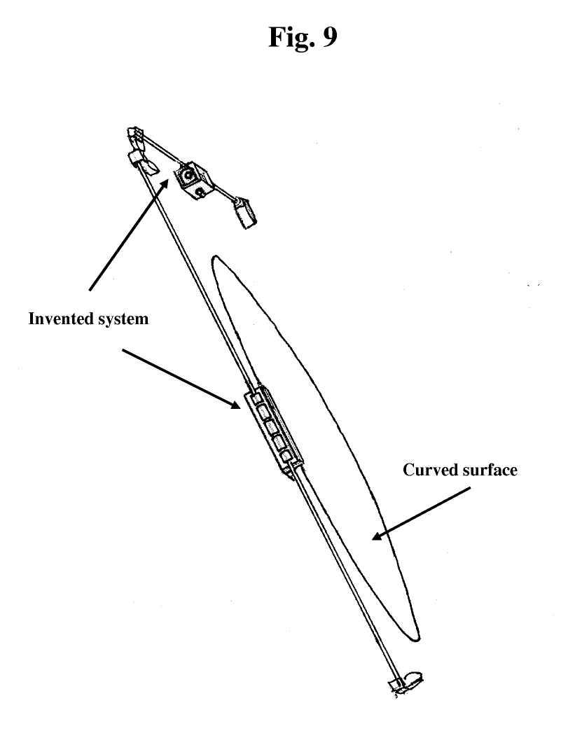

11. The monitored writing area of the above claims are any writing area which is a planar surface, rough planar surface, curved surface or close to planar surface including “Whiteboard”, “Display unit” which is including CRT display, LCD display, plasma display, DLP display and any other computer controlled display units, “Projector Screen” and writing pad, but not limited to. See FIG. 9

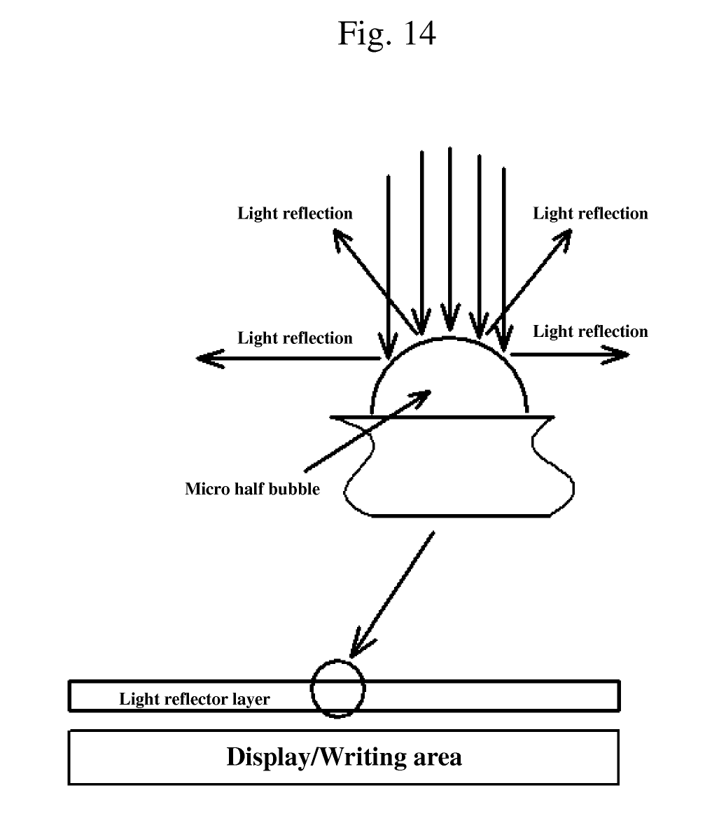

12. The writing instrument of claim 1 can be laser pointer and laser pointer light beam. The laser pointer just works like a pen a-like writing instrument as usual, and the laser pointer light beam works a little bit differently. The image sensors captures images and identifies the light spot that the laser pointer shines to and the system identifies the relative angle of the light spot, such that the location can be calculated. The laser pointer as a writing instrument can be specially designed with lights of different wave length, thus can be identified for different functions. For example: Red color with function same as left mouse button and green color with function same as right mouse button and so on. To further enhance the readability of the laser light spot, a transparent layer may be installed on top of the monitored writing area which can be a LCD monitor, projector screen, whiteboard, wall but not limited to as said list, to improve the light reflection to enhance the readability of the laser light beam spot. The transparent layer can be any material including glass and plastics, planar or non planar materials with and without special designed shape of surface and depends on application, for example: the surface can be a slightly rough surface with micro half bubble to reflect light more for the light spot, to be seen easily by the image sensor. The shape is not limited to half bubble but any shape that works best for the application. See FIG. 14
